(19) United States
(12) Patent Application Publication
(10) Pub. No.: US 2017/0169748 A1
(43) Pub. Date: Jun. 15, 2017

(54) DISPLAY APPARATUS AND PIXEL ARRAY THEREOF

(71) Applicant: EVERDISPLAY OPTRONICS (SHANGHAI) LIMITED, Shanghai City (CN)

(72) Inventor: Kaikai CHEN, SHANGHAI CITY (CN)

(73) Assignee: EVERDISPLAY OPTRONICS (SHANGHAI) LIMITED, SHANGHAI CITY (CN)

(21) Appl. No.: 15/139,490

(22) Filed: Apr. 27, 2016

(30) Foreign Application Priority Data
Dec. 15, 2015 (CN) 201510941211.X

(51) Int. Cl. G09G 3/20; G09G 3/3208

(52) U.S. Cl. CPC G09G 3/2003; G09G 3/3208; G09G 2300/0452; G09G 2300/0443; G09G 2320/02

(57) ABSTRACT

A pixel array includes a plurality of pixel units repeatedly arranged along a row direction and a column direction, wherein each of the pixel units includes two first sub pixels, a second sub pixel and a third sub pixel, wherein the second sub pixel and the third sub pixel are disposed in adjacent two sub pixel rows, and the two first sub pixels are disposed in adjacent two sub pixel rows, such that two second sub pixels in two pixel of the units adjacent along the row direction in the pixel array are disposed in the same sub pixel row, and two third sub pixels in two of the pixel units adjacent along the row direction in the pixel array are disposed in another sub pixel row.

### CROSS-REFERENCE TO RELATED APPLICATIONS

This application is based upon and claims priority to Chinese Patent Application 201510941211.X, filed on Dec. 15, 2015, the entire contents of which are incorporated herein by reference.

### TECHNICAL FIELD

The present disclosure relates to the field of display technology, and more particularly, to a display apparatus and a pixel array thereof.

### BACKGROUND

Recently, organic light emitting diode (OLED) technology is developing rapidly, and is becoming a most promising technology that will possibly replace liquid crystal displays (LCDs).

In the prior art, a display panel includes a substrate and a pixel array disposed on the substrate. The pixel array includes a plurality of pixel units, each of which is constituted by three sub pixels having different colors. Each sub pixel is connected with a scan line and a data line on the substrate, the scan line selects the sub pixel and the sub pixel displays according to signals form the data line, thereby displaying images with the display panel.

In an example of the prior art, as illustrated in FIG. 1, a pixel array 100 includes a plurality of pixel units 110, and each pixel unit 110 includes a blue sub pixel B, a red sub pixel R and a green sub pixel G. Herein, when blue sub pixels B in one row of pixel units 110 are disposed adjacent to upper edges of the pixel units, blue sub pixels B in adjacent two rows of pixel units are disposed adjacent to upper edges of the pixel units. In the same row of pixel units 110, each of the blue sub pixels B is disposed adjacent to the same direction. Accordingly, in the pixel array 100, a distance between two sub pixels B adjacent in the column direction is either very small or very large, such that a dim black line may occur at two rows of pixel units 110 with very small distance between blue sub pixels B, e.g. the plurality of blue sub pixels B illustrated within two adjacent dashed lines, when displaying a blue image, thereby deteriorating display effect.

In another example of the prior art, as illustrated in FIG. 2, a pixel array 200 is similar to that of FIG. 1. However, the pixel array 200 differs from that of FIG. 1 in that two blue sub pixels B of adjacent pixel units 210 in the same row of pixel units 210 are interleaved. Such a pixel array 200 may prevent the dim black line in FIG. 1 from occurring, however, a zigzag problem as illustrated by the dished lines may occur while displaying a straight line.

### SUMMARY

There are provided a display apparatus and a pixel array thereof that may improve display effect of the display apparatus.

The present disclosure, according to one aspect thereof, provides a pixel array including a plurality of pixel units repeatedly arranged along a row direction and a column direction, wherein each of the pixel units includes two first sub pixels, a second sub pixel and a third sub pixel, wherein the second sub pixel and the third sub pixel are disposed in adjacent two sub pixel rows, and the two first sub pixels are disposed in adjacent two sub pixel rows, such that two second sub pixels in two of the pixel units adjacent along the row direction in the pixel array are disposed in the same sub pixel row, and two third sub pixels in two of the pixel units adjacent along the row direction in the pixel array are disposed in another sub pixel row.

According to another aspect of the present disclosure, there is further provided a display apparatus including the above pixel array.

### BRIEF DESCRIPTION OF THE DRAWINGS

The above and other features and advantages of the present disclosure will become more apparent by describing its example implementations in detail with reference to the drawings.

FIG. 1 is a schematic diagram of a pixel array according to an embodiment in the prior art.

FIG. 2 is a schematic diagram of a pixel array according to another embodiment in the prior art.

FIG. 3 is a schematic diagram of the display apparatus of the present disclosure.

FIG. 4 is a schematic diagram of a pixel array according to a first embodiment of the present disclosure.

FIG. 5 is a schematic diagram of a pixel array according to a second embodiment of the present disclosure.

FIG. 6 is a schematic diagram of a pixel array according to a third embodiment of the present disclosure.

### DETAILED DESCRIPTION

Example implementations will be described in further detail with reference to the accompanying drawings. The example implementation, however, may be embodied in various forms, and should not be construed as being limited to the implementations described herein. Rather, these implementations are provided so that the present invention will become thorough and complete, and will fully convey the concept of the inventive concept to those skilled in the art. In the drawings, the same reference numerals denote the same or like structures, and thus their repeated description will be omitted.

The described features, structures or characters may be combined in one or more embodiments in any suitable manner. In the following description, numerous specific details are provided so as to allow a full understanding of the embodiments of the present disclosure. However, those skilled in the art will recognize that the technical solutions of the present disclosure may be implemented without one or more of the specific details, or other methods, components, materials and so on may be used. In other cases, the well-known structures, materials or operations are not shown or described in detail to avoid obscuring various aspects of the present disclosure.

The drawings in the present disclosure are provided only to illustrate relative position relations, sizes of some parts are exaggeratedly depicted for ease understanding, sizes depicted in the drawings does not represent actual scale.

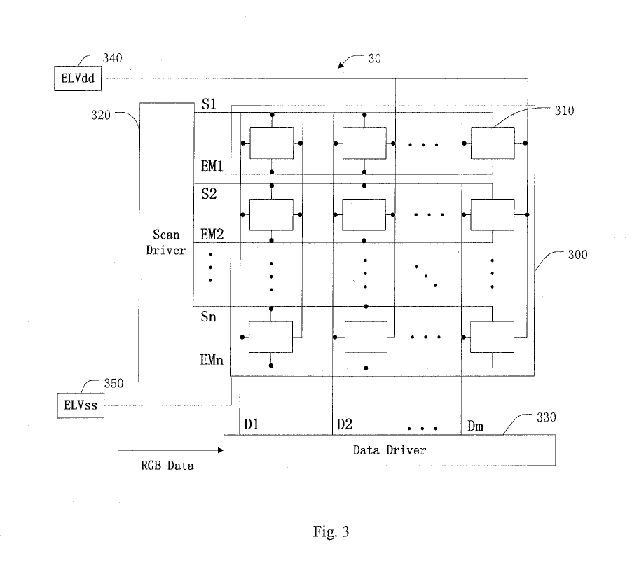

FIG. 3 is a schematic diagram of the display apparatus of the present disclosure. The display apparatus is an organic light emitting diode (OLED) display apparatus 30. Referring to FIG. 3, the OLED display apparatus 30 includes at least a display unit 300, a scan driver 320 and a data driver 330. Other apparatus and/or elements may be included in the OLED display apparatus 30.

The display unit 300 may include a plurality of pixel units 310 connected to scan lines (S1 to Sn), light emitting control lines (EM1 to EMn) and data lines (D1 to Dm). In addition, one pixel unit 310 may be constituted by four sub pixels.

The display unit 300 may display an image corresponding to a first power source (ELVdd) provided externally and a second power source (ELVss) provided externally. The display unit 300 may also display an image corresponding to a scan signal provided by the scan lines S1 to Sn generated by the scan driver 320, a light emitting control signal provided by the light emitting control lines EM1 to EMn, and a data signal provided by the data lines D1 to Dn generated by the data driver 330.

The scan driver 320 may generate the scan signal and the light emitting control signal. The scan signal generated in the scan driver 320 may be provided sequentially to the scan lines (S1 to Sn), and the light emitting control signal may be provided sequentially to each of the light emitting control lines (EM1 to EMn). The scan signal and the light emitting control signal may also not be provided sequentially to the scan lines S1 to Sn and the light emitting control lines EM1 to EMn. In other embodiments, the light emitting control signal may also be generated by a light emitting control driver.

The data driving 330 may receive an input signal such as RGB data and generate the data signal corresponding to the received input signal. The data signal generated in the data driver 330 may be provided to the pixel unit 310 via the data lines (D1 to Dm) so as to be synchronized with the scan signal. The data signal may also be provided to the data lines D1 to Dm in an asynchronous manner.

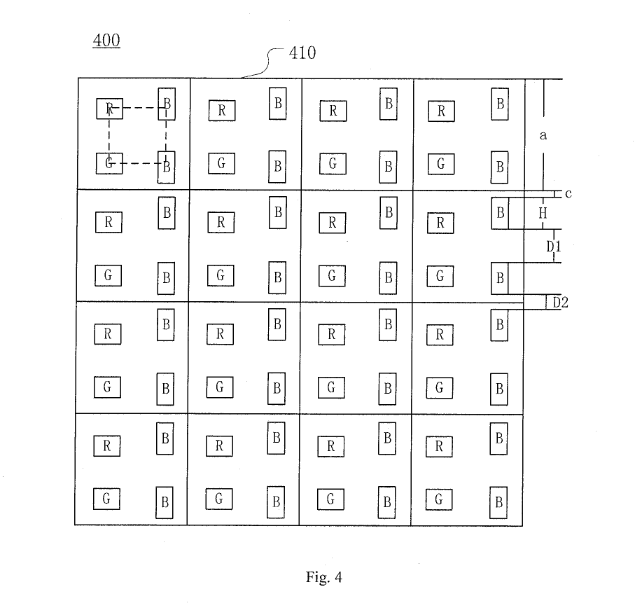

In the pixel array of the present embodiment, four sub pixels represent one pixel unit 310 substantially, so as to improve the problems such as the pixel array displaying the dim black line or the zigzag problem while displaying a straight line. In particular, the pixel array provided by the present disclosure includes a plurality of pixel units repeatedly arranged in the row direction and the column direction. Each pixel unit includes two first sub pixels (for example, blue sub pixels), a second sub pixel (for example, red sub pixel) and a third sub pixel (for example, green sub pixel). In one embodiment, the red sub pixel and the green sub pixel are disposed in adjacent sub pixel rows, such that two red sub pixels in two of the pixel units adjacent along the row direction in the pixel array are disposed in the same sub pixel row, and two green sub pixels in two of the pixel units adjacent along the row direction in the pixel array are disposed in another sub pixel row. The pixel array will be illustrated in further detail by referring to FIG. 4 to FIG. 6.

### The First Embodiment

Referring to FIG. 4, which is a schematic diagram of the pixel array 400 of the first embodiment of the present disclosure. The pixel array 400 includes a plurality of pixel units 410 arranged repeatedly in the row direction X and the column direction Y. One pixel unit 410 corresponds to one pixel dot when the pixel array 400 displays an image. Each pixel unit 410 includes two blue sub pixels B, a red sub pixel R and a green sub pixel G. The pixel unit 410 displays one color by adjusting gray scales of the sub pixels of the three different colors.

In the present embodiment, the four sub pixels in each pixel unit 410 are arranged in the same manner. In particular, the sub pixels in each pixel unit 410 constitute a 2×2 array in unit of sub pixels. A first sub pixel row is constituted by successively arranged red sub pixel R and blue sub pixel B. The second sub pixel row is constituted by successively arranged green sub pixel G and blue sub pixel B. In one embodiment, the red sub pixel R in the first sub pixel row and the green sub pixel G in the second sub pixel row constitute the first sub pixel column. The blue sub pixel B in the first sub pixel row and the blue sub pixel B in the second sub pixel row constitute the second sub pixel column. In this manner, the pixel array 400 includes sub pixel rows in which red sub pixels R and blue sub pixels B are arranged alternatively, and sub pixel rows in which green sub pixels G and blue sub pixels B are arranged alternatively.

Lines connecting centers of the four sub pixels form a quadrilateral shape. For example, lines connecting centers of the four sub pixels may form a rectangular shape, a parallelogram shape or other irregular quadrilateral shapes. In the present embodiment, lines connecting centers of the four sub pixels form a rectangular shape, and the two blue sub pixels B form an edge of the rectangular shape extending along the column direction.

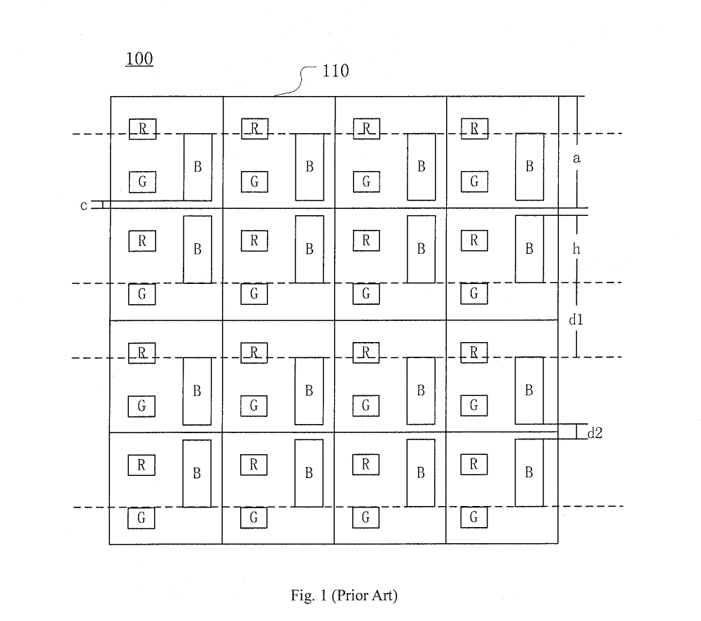

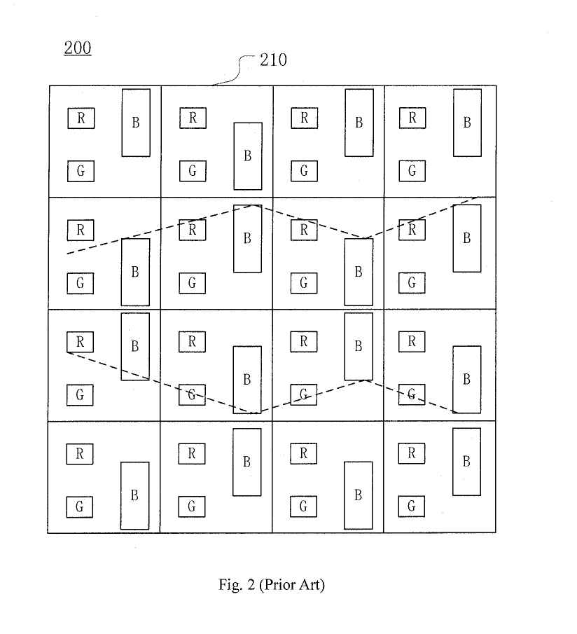

In one pixel unit 410, the distance in the column direction between the two blue sub pixels B in the same sub pixel column may be determined according to the factors such as the size of the pixel array 400, manufacturing process of each sub pixel, and the like, such that the distance D1 in the column direction between the two blue sub pixels B in each pixel unit 410 of the pixel array 400 provided by the present disclosure is smaller than the distance d1 between the two blue sub pixels B having relatively greater distance in the two pixel units adjacent in the column direction according to the prior art (as illustrated in FIG. 1 or FIG. 2). Further, a difference between the distance D1 in the column direction between the two blue sub pixels B in each pixel unit 410 of the pixel array 400 and the distance D2 between two blue sub pixels adjacent in the column direction in the two pixels 410 adjacent in the column direction is also smaller than a difference between the distance d1 between the two blue sub pixels B having relatively greater distance in the two pixel units adjacent in the column direction and the distance d2 between the two blue sub pixels B having relatively smaller distance in the two pixel units adjacent in the column direction according to the prior art (as illustrated in FIG. 1 or FIG. 2). Accordingly, distances between the blue sub pixels B may be equalized, thereby improving the display effect of the display apparatus.

Since human eyes are insensitive to blue color, in one pixel unit 410, a sum of the areas of the two blue sub pixels B is greater than an area of the red sub pixel R or that of the green sub pixel G, and meanwhile, the sum of the areas of the two blue sub pixels B is equal to or smaller than a sum of the areas of the red sub pixel R and the green sub pixel G, such that the proportion occupied by the blue sub pixels B in the pixel unit 410 may be equalized. In the present embodiment, the two blue sub pixels B in each pixel unit 410 have the same area. In some alternative examples, areas of the two blue sub pixels B in each pixel unit 410 may be different. In the embodiment where areas of the two blue sub pixels B in each pixel unit 410 are different, blue pixels B at corresponding positions in each pixel unit 410 have the same area. In the both cases where blue pixels B have the same area or different areas, blue image may become more delicate, thereby eliminating the problem of displaying the black line with the pixel array according to the prior art (as illustrated in FIG. 1 and FIG. 2). Meanwhile, since human eyes are insensitive to blue color, while a blue line is actually displayed, a problem of the blue line having a relatively greater thickness will be insignificant.

In a particular embodiment, the pixel array illustrated in FIG. 4 has a same size with that illustrated in FIG. 1. The pixel unit 410 of the pixel array 400 has a same size and a same length “a” with those of the pixel unit 110 of the pixel array 100. The red sub pixel R of the pixel array 400 has a same size with that of the red sub pixel R of the pixel array 100. The green sub pixel G of the pixel array 400 has a same size with that of the green sub pixel G of the pixel array 100. The blue sub pixel B of the pixel array 400 has a same width with that of the blue sub pixel B of the pixel array 100, and the blue sub pixel B of the pixel array 400 has a length H that is 0.5 times smaller than the length h of the blue sub pixel B of the pixel array 100. In the column direction, blue sub pixels B in the pixel array 400 and those in the pixel array 200 have the same closest distance c between the sub pixels and the boundaries of the pixel units. Accordingly, the distance d1 between the two blue sub pixels B having relatively greater distance in the two pixel units adjacent in the column direction in the pixel array 100 may be “2a-2h-2c”, and the distance D1 in the column direction between two blue sub pixels B in each pixel unit 410 in the pixel array 400 may be “a-2H-2c”. Since H=0.5h, d1 is greater than twice of D1. In addition, since the above D2=d2=2c, it can be further determined that “d1-d2” has a value greater than that of “D1-D2”, such that distance between the blue sub pixels B may be equalized.

### The Second Embodiment

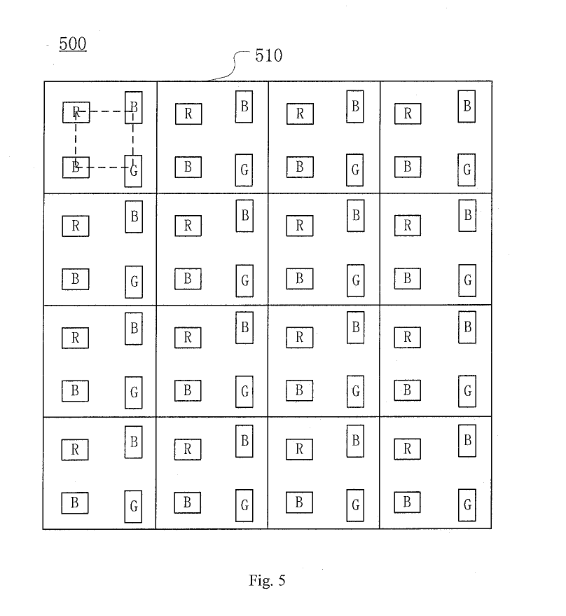

Referring to FIG. 5, a pixel array 500 illustrated in FIG. 5 is similar to the pixel array 400, and the pixel array 500 differs from the pixel array 400 in that in the quadrilateral shape formed by the lines connecting the centers of the four sub pixels of each pixel unit 510, the two blue sub pixels B are disposed at diagonal positions of the quadrilateral shape. In particular, the sub pixels in each pixel unit 510 constitute a 2×2 array in unit of sub pixels. A first sub pixel row is constituted by successively arranged red sub pixel R and blue sub pixel B. The second sub pixel row is constituted by successively arranged blue sub pixel B and green sub pixel G. In some alternative examples, the position of the red sub pixel R and the position of the green sub pixel G in each pixel unit 510 may be interchanged as long as the red sub pixels R are not disposed in the same line with the green sub pixels G, thereby improving the problem of the zigzag problem while displaying a straight line.

In the present embodiment, since the two blue sub pixels B in each pixel unit 510 are diagonally disposed, it will facilitate the manufacturing process of the mask that defines the pattern of the blue sub pixels B in the process of forming the blue sub pixels B. In particular, when the blue sub pixels B are positioned in the same sub pixel column, the metal mask plate used in the process of forming the blue sub pixels B is a slit mask having bar shaped slit openings, while when the blue sub pixels B are diagonally disposed, the metal mask plate used in the process of forming the blue sub pixels B is a slot mask having interleaving slot openings. The slot mask is easier to be manufactured than the slit mask, and thus the diagonally disposed blue sub pixels B may facilitate the manufacturing process of the blue sub pixels B.

### The Third Embodiment

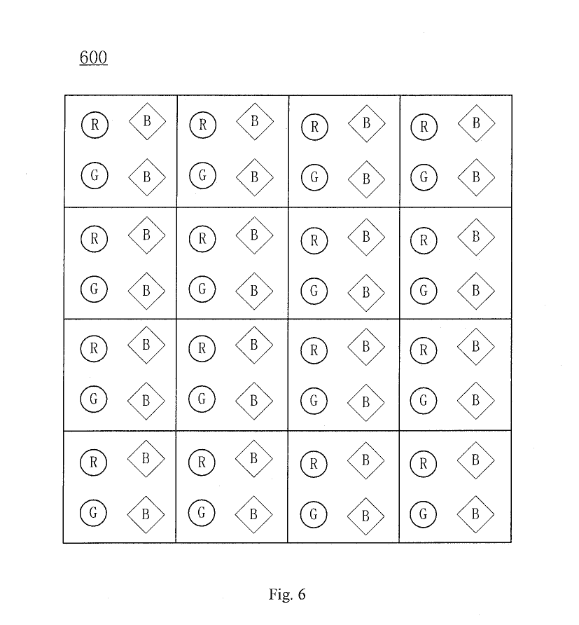

Referring to FIG. 6, a pixel array 600 illustrated in FIG. 6 is similar to the pixel array 400, and the pixel array 600 differs from the pixel array 400 in that each sub pixel has a non-rectangular shape. For example, the red sub pixel R and the green sub pixel G are circular sub pixels, and the blue sub pixel B is a rhombic sub pixel. Other different sub pixel shapes may be implemented in the present disclosure, which will not be described herein.

In comparison with the prior art, by improving pixel arrangement, each pixel unit of the present disclosure includes two blue sub pixels to balance the distance between blue sub pixels, thereby improving the problems such as the pixel array displaying the dim black line or the zigzag problem while displaying a straight line. In the present disclosure, by further having red sub pixels and green sub pixels positioned in different rows, the zigzag problem may be further improved.

Hereinabove, exemplary implementations of the present disclosure are illustrated and described in detail. It should be appreciated that the present disclosure is not limited to the disclosed implementations, rather, the present disclosure intends to cover various modifications and equivalent alternatives included in the scope of the appended claims.

What is claimed is:

1. A pixel array comprising a plurality of pixel units repeatedly arranged along a row direction and a column direction, wherein each of the pixel units comprises:
two first sub pixels;
a second sub pixel; and
a third sub pixel, wherein
the second sub pixel and the third sub pixel are disposed in adjacent two sub pixel rows, and the two first sub pixels are disposed in adjacent two sub pixel rows, such that two second sub pixels in two of the pixel units adjacent along the row direction in the pixel array are disposed in the same sub pixel row, and two third sub pixels in two of the pixel units adjacent along the row direction in the pixel array are disposed in another sub pixel row.

2. The pixel array according to claim 1, wherein lines connecting centers of the four sub pixels of each of the pixel units form a quadrilateral shape, and the two first sub pixels are disposed at diagonal positions of the quadrilateral shape.

3. The pixel array according to claim 1, wherein in each of the pixel units:
the two first sub pixels are disposed in the same sub pixel column.

4. The pixel array according to claim 1, wherein in each of the pixel units:
the two first sub pixels have the same area size.

5. The pixel array according to claim 1, wherein in each of the pixel units:
the two first sub pixels have different area sizes.

6. The pixel array according to claim 5, wherein any one of the two first sub pixels at corresponding positions in the pixel units has the same area size.

7. The pixel array according to claim 1, wherein in each of the pixel units:
a sum of the areas of the two first sub pixels are greater than an area of the second sub pixel or an area of the third sub pixel, and is smaller than a sum of the areas of the second sub pixel and the third sub pixel.

8. The pixel array according to claim 1, wherein the sub pixels have one or more shapes of triangle, quadrilateral, polygon and circular shape.

9. A display apparatus comprising a pixel array, wherein the pixel array comprises a plurality of pixel units repeatedly arranged along a row direction and a column direction, wherein each of the pixel units comprises:
two first sub pixels;
a second sub pixel; and
a third sub pixel, wherein
the second sub pixel and the third sub pixel are disposed in adjacent two sub pixel rows, and the two first sub pixels are disposed in adjacent two sub pixel rows, such that two second sub pixels in two of the pixel units adjacent along the row direction in the pixel array are disposed in the same sub pixel row, and two third sub pixels in two of the pixel units adjacent along the row direction in the pixel array are disposed in another sub pixel row.

10. The display apparatus according to claim 9, wherein lines connecting centers of the four sub pixels of each of the pixel units form a quadrilateral shape, and the two first sub pixels are disposed at diagonal positions of the quadrilateral shape.

11. The display apparatus according to claim 9, wherein in each of the pixel units:
the two first sub pixels are disposed in the same sub pixel column.

12. The display apparatus according to claim 9, wherein in each of the pixel units:
the two first sub pixels have the same area size.

13. The display apparatus according to claim 9, wherein in each of the pixel units:
the two first sub pixels have different area sizes.

14. The display apparatus according to claim 13, wherein any one of the two first sub pixels at corresponding positions in the pixel units has the same area size.

15. The display apparatus according to claim 9, wherein in each of the pixel units:
a sum of the areas of the two first sub pixels are greater than an area of the second sub pixel or an area of the third sub pixel, and is smaller than a sum of the areas of the second sub pixel and the third sub pixel.

16. The display apparatus according to claim 9, wherein the sub pixels have one or more shapes of triangle, quadrilateral, polygon and circular shape.
